(19) United States
(12) Patent Application Publication
(10) Pub. No.: US 2006/0090760 A1
(43) Pub. Date: May 4, 2006

(54) Release mechanism for masks

(76) Inventors: Lewis George Gradon, Auckland (NZ); Alastair Edwin McAuley, Auckland (NZ); Christopher Earl Nightingale, Auckland (NZ); Ivan Milivojevic, Auckland (NZ); Aidan Mark Shotbolt, Dunedin (NZ)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 10/527,680

(22) PCT Filed: Sep. 15, 2003
(86) PCT No.: PCT/NZ03/00206

§ 371 Date: Sep. 15, 2005

(30) Foreign Application Priority Data
Oct. 2, 2002 (NZ) 521744

(51) Int. Cl. A62B 18/08

(52) U.S. Cl. 128/206.27; 128/207.11; 128/207.17

(57) ABSTRACT

Mask (2) and headgear (5) have quick release mechanism. In emergency, patient pulls release cord (14) causing mask to fall from face. Can be used for general respiratory care or with a ventilator. Can be used in aviation, mining or firefighting.

### BACKGROUND OF TH INVENTION

1. Field of the Invention

This invention relates to headgear and masks particularly though not solely for use in providing continuous positive airway pressure (CPAP) therapy to patients suffering from obstructive sleep apnoea (OSA). In particular the present invention relates to headgear and nasal masks that have a quick release mechanism that allows a user to easily and quickly remove the mask and headgear.

2. Summary of Prior Art

In the art of respiration devices, there are well known a variety of respiratory masks which cover the nose and/or mouth of a human user in order to provide a continuous seal around the nasal and/or oral areas of the face, such that gas may be provided at positive pressure within the mask for consumption by the user. The uses for such masks range from high altitude breathing (i.e. aviation applications), to mining and fire fighting applications and to various medical diagnostic and therapeutic applications.

Headgear is known by which a gas delivery mask is maintained in contact with the face of a patient. Such headgear incorporated upper and lower straps, each having opposite ends threading through connector elements provided on the opposite side and/or the top of the mask. Each strap includes releasable securing means, for example, a VELCRO™ fastener, such that each strap may be adjusted as required to produce an effective seal between the mask and the patient's face. The mask and headgear must be comfortable and adaptable to different users' heads and/or faces and must be easily removable.

U.S. Pat. No. 5,441,046 of Respironics, Inc. discloses a quick release and connect mechanism used with nasal and/or oral gas delivery masks. The mechanism attaches to the mask and to the headgear acting as a connection link. While under normal use the connection remains intact. However, when a release cord attached to the headgear is pulled, the mechanism is inclined and becomes free from one of the headgear straps and the connection is broken, allowing the mask to fall from the user's face. The connection link has an elongated opening which receives the headgear strap and allows for the securing of the mask to the face of a patient. When the release cord is pulled and the mechanism inclined the strap is released from the connection mechanism.

WO02/47749 of Resmed Limited discloses headgear for securing and positioning a mask suitable for the treatment of sleep disorder breathing. The headgear includes a quick release mechanism near the front of the face that attaches the headgear to the mask. The quick release mechanism comprises a release loop of cord material, a rectangular length of hook material and a rectangular length of composite fabric which can bind to the hook material. A cord is attached and hangs from the composite fabric such that when the cord is pulled by the user the composite fabric is removed from the hook material thereby releasing the mask from the user's face.

U.S. Pat. No. 6,422,238 of Resmed Limited discloses headgear for securing a respiratory mask to a patient and incorporates a quick release mechanism. The headgear has at least one strap extending from each side of the mask, the straps being releasably fastened rearwards of the patients face to secure the mask. The headgear further includes release means in the form of a pull cord attached to an overlying strap at its region of fastening to the underlying strap. When the headgear is positioned on the patient's head, the release mechanism is situated at the back of the head and the cord runs through loops towards the front of the mask system. The pull cord is guided forward to allow easy access to the user and that is able to be gripped at the front of the patient. Pulling forward on the cord releases the mask from the patient's face as the cord causes the straps to be released from one another.

The mask release mechanisms of the abovementioned patents and patent applications either do not immediately remove the mask from the user's face, tend to be awkward or require some strength to initiate the release mechanism.

### SUMMARY OF INVENTION

It is an object of the present invention to provide a quick release mechanism for a mask which goes some way to overcoming the abovementioned disadvantages in the prior art of which will at least provide the industry with a useable choice.

In a first aspect the present invention consists in a release mechanism for an interface to enable a user to quickly remove said interface from said users' face, comprising or including:

at least one strap having two ends where one end in use is flexibly coupled to releasably connecting means provided at least on one side of said mask, and the other of said two ends flexibly coupled to attachment means at the other side of said mask, said strap extending around the back of the user's head,

a cord attached to said releasable connecting means which when said mask is in use and said cord is pulled by said user said releasable connecting means causes said at least one strap to be released from said mask thereby causing said mask to fall from said users' face.

In a second aspect the present invention consists in a mask having a release mechanism that enables a user to quickly remove said mask from said user's face, comprising or including:

at least one strap having two ends each adapted to, in use, be flexibly coupled to releasable connecting means provided at least on one side of said mask, and attachment means at the other side of said mask, and around the back of the user's head,

a cord attached to said releasable connecting means, at least one of said attachment means, which when said mask is in use and said cord is pulled by said user said releasable connecting means causes said at least one strap to be released from said mask thereby causing said mask to fall from said user's face.

In a third aspect the present invention consists in a patient interface for delivering a supply of gases to a user comprising or including:

securement means attached to or around the head of said user,

engaging means adapted to slidingly engage said securement means with said patient interface,

release mechanism coupled between said securement means and said engaging means which when actuated by said user causes the separation of said engaging means and said securement means.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

### BRIEF DESCRIPTION OF DRAWINGS

One preferred form of the present invention will now be described with reference to the accompanying drawings in which;

FIG. 1 is a side view of a user wearing a mask that may utilise the release mechanism of the present invention,

FIG. 2 is a perspective view of a mask, headgear and release mechanism of the present invention,

FIG. 3 is a perspective view of the harnessing clip and release cord forming the release mechanism of the present invention,

FIG. 4 is a plan view of a sliding engagement loop for a mask that may have disposed at its ends the release mechanism of the present invention,

FIG. 5 is a perspective view of the harnessing clip of the present invention when the male and female connectors are apart,

FIG. 6 is a plan view an alternative form of the harnessing clip of the present invention when the male and female connectors are apart,

FIG. 7 is a side view of the harnessing clip of FIG. 5, and

FIG. 8 is a cross-sectional side view of the harnessing clip of FIG. 5, showing the location of the release cord.

### DETAILED DESCRIPTION OF THE PREFERRED EMBODIMENTS

The present invention provides improvements in the field of nasal masks for use in ventilation therapy. In particular, a mask and headgear are described that has a quick release mechanism where in an emergency a patient need only pull a release cord to cause the mask to fall from his or her face. It will be appreciated that the headgear and mask as described in the preferred embodiment of the present invention can be used in respiratory care generally or with a ventilator. Alternatively, the mask could be used for other applications such as in aviation, mining, or fire fighting.

Nasal Mask

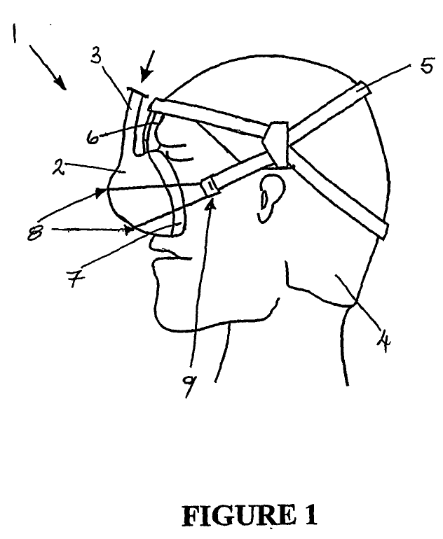

Referring to FIG. 1 a nasal mask and headgear (generally indicated as 1) incorporating the release mechanism of a present invention is shown in detail. The mask includes a hollow body 2 with an inlet 3 connected to an inspiratory conduit (not shown), a forehead rest 6 and cushion 7 located between the patient's face and hollow body 2. The inspiratory conduit is connected to various tubing and to a humidifier and blower or the like to supply the patient 4 with gases for ventilation therapy. The mask 2 is positioned around the nose of the patient 4 with the headgear 5 secured around the back of the head of the patient 4. The restraining force from the headgear 5 on the hollow body 2 and the forehead rest 6 ensures enough compressive force on the mask cushion 7 to provide an effective seal against the patient's face.

In other forms of the present invention a full face mask could utilise the release mechanism as described below.

Mask Headgear

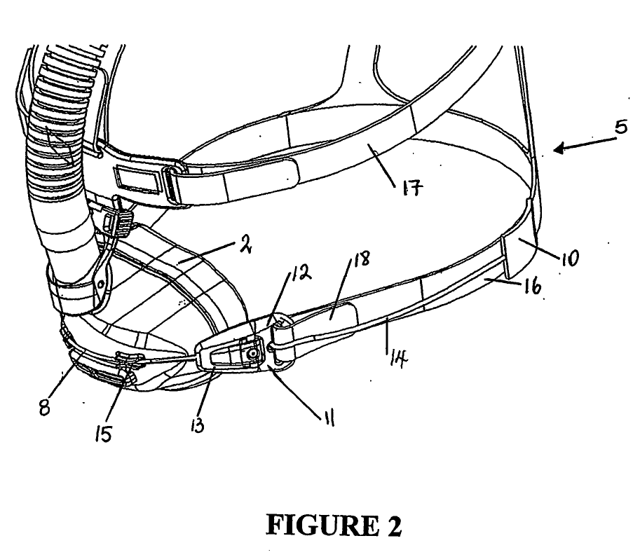

As shown in FIG. 1, the release mechanism of the present invention preferably utilises a sliding engagement strap, similar to that as described in co-pending U.S. patent application Ser. No. 09/881,633 and/or U.S. patent application Ser. No. 10/07221, between the headgear 5 and the hollow body 2. This means that at least one of the headgear straps, for example, headgear strap 16 in FIG. 2, is flexibly coupled to the mask via the sliding strap 8. This is achieved with a sliding strap loop, running through the harnessing clips of the release mechanism 9 on either side of the headgear 5 and over the top of the hollow body 2. The loop 8 is reciprocally engaged with guides (15 in FIG. 2) mounted on the top surface of the hollow body 2. The guides 15 constrain the loop (8, in FIG. 2) but allow it to slide in and out, meaning the headgear 5 can move laterally, independently of the hollow body 2.

In other forms of the sliding engagement strap there may merely be a single elongate sliding strap 8 (as shown in FIG. 2), the ends of which are attached to a headgear strap 16. The advantage of a sliding engagement strap for the headgear is as the face of the patient is contorted during changing sleeping positions the headgear is able to move with the changes in position while the mask is left in the correct position on the nose of the patient and an effective seal is maintained.

The mask may be provided with additional guides that allow the user to adjust the position of the loop 8, giving the ability to keep different pressure on the seal depending on the loop position.

To further ensure user comfort and effect pressure on the mask cushion 7, the headgear 5 may be constructed using two straps (16, 17) running around the back of the user's head (as shown in FIG. 2 one 16 attached to the sliding strap 8 and the other 17 to the forehead rest on the mask) or with the partial skull cap or any other configurations as are known in the art. In this case the straps or partial skull cap would be constructed using neoprene, but may also be constructed using any material as known in the art which will be comfortable for the user. A preferred sliding engagement strap, whether a loop or single engagement strap, is made from TEFLON™ or polyacetal using injection moulding techniques to give a polished finish. This material, is similar to other nylon based derivatives, with its polished finish has a particularly low friction coefficient, and therefore slides with respect of the mask body with very little resistance.

Release Mechanism

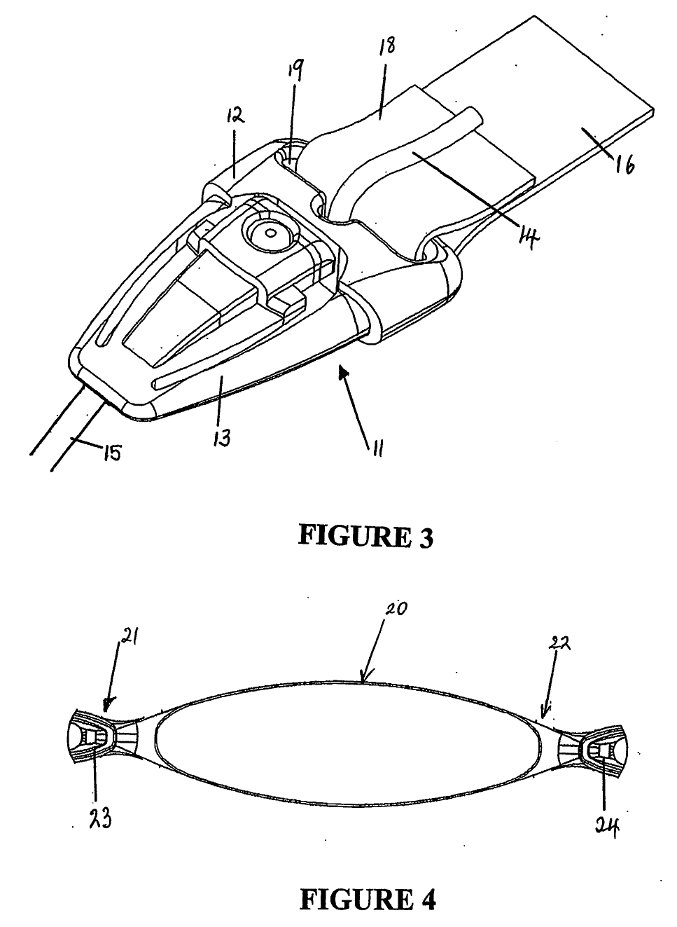

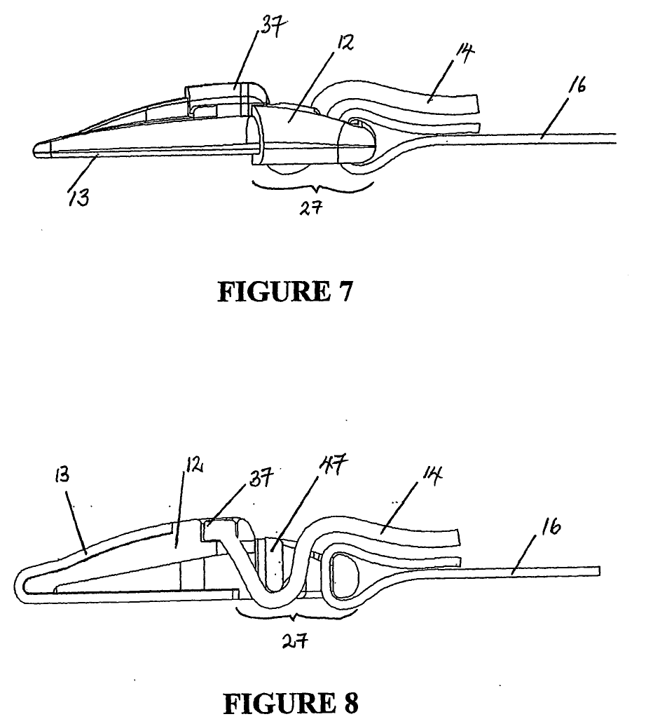

The release mechanism of the present invention is shown particularly in FIGS. 3 to 8, and in association with a nasal mask and headgear in FIG. 2. Referring to FIGS. 2 and 3, the release mechanism comprises a harnessing clip 11, which consists of two parts, a male connector 12 and female connector 13 capable of being coupled, and a release cord 14. When the release cord 14 is pulled by the patient or user wearing the mask the male connector 12 is released from the female connector 13 causing the mask 2 and associated headgear 5 to fall from the user's face. In use, when the male connector 12 and female 13 connector are coupled, as in FIG. 2, at least one headgear strap, in this instance strap 16, extends from the attachment end of the male connector 12. For example the headgear strap 16 is threaded through an elongated aperture in the end of the male connector 12 and the end 18 of the strap 16 is permanently attached to the rest of the body of the headgear strap 16 by some type of fastener, such as VELCRO™.

The other side of the mask that is not shown in FIG. 2 may also have a similar harnessing clip that attaches the mask to the other end of headgear strap (not shown). In other forms the harnessing clip and strap may not have a release cord but merely be a clip to attach the headgear to the mask. In yet other forms of the present invention one side of the mask may be provided with the harnessing clip 11 and release cord 14, but other side with a simple loop that a headgear strap can be attached to.

When the mask is in use the end of the release cord 14 is stored in an attached manner to the headgear strap 16. In the preferred form of the release mechanism the end of the release cord 14 has an attachment area 10 that is fastened against the headgear strap by way of a hook and loop type fastener, such as VELCRO™ in order to keep the release cord away from the user's face. Other appropriate means of fastening the release cord to the headgear are possible, such as a snap fitting or the like.

FIG. 2 also shows the preferred embodiment of the harnessing clip 11 where the female connector 13 is flexibly coupled to the mask 2 and the headgear strap 16 is attached to the male connector 12. In other forms of the present invention the male and female connectors of the harnessing clip may be provided in an opposing manner, for example, where a female connector is flexibly coupled to the mask and the male connector is attached to the headgear strap. The flexible coupling between the mask 2 and harnessing clip 11 is achieved by a sliding engagement strap 15 as described above. In this embodiment the female connector 13 is integrally formed with the sliding strap 15, such that each end of the sliding strap terminates with a female connector 13. It must be appreciated that in other forms of the present invention, when the male and female connectors are opposed, that the sliding strap will be integrally formed with the male connector.

The harnessing clip 11 and sliding strap 15 are preferably formed in a plastics material, such as polycarbonate, acetal or nylon and integrally formed during a moulding process.

An alternative form of the sliding strap having two integral female connectors is shown in FIG. 4. The sliding strap in this form is a loop 20 formed in an elliptical shape where the ends of the ellipse terminate in integrally formed connectors. These connectors are preferably female connectors 23, 24 similar to those described above. It must be appreciated that only one connector 23 may be provided with the loop 20. The other side of the loop could be provided with existing attachment mechanisms as known in the prior art. In other forms the male connector may be integrally formed with the loop 20 and the female connector attached to the headgear strap 16.

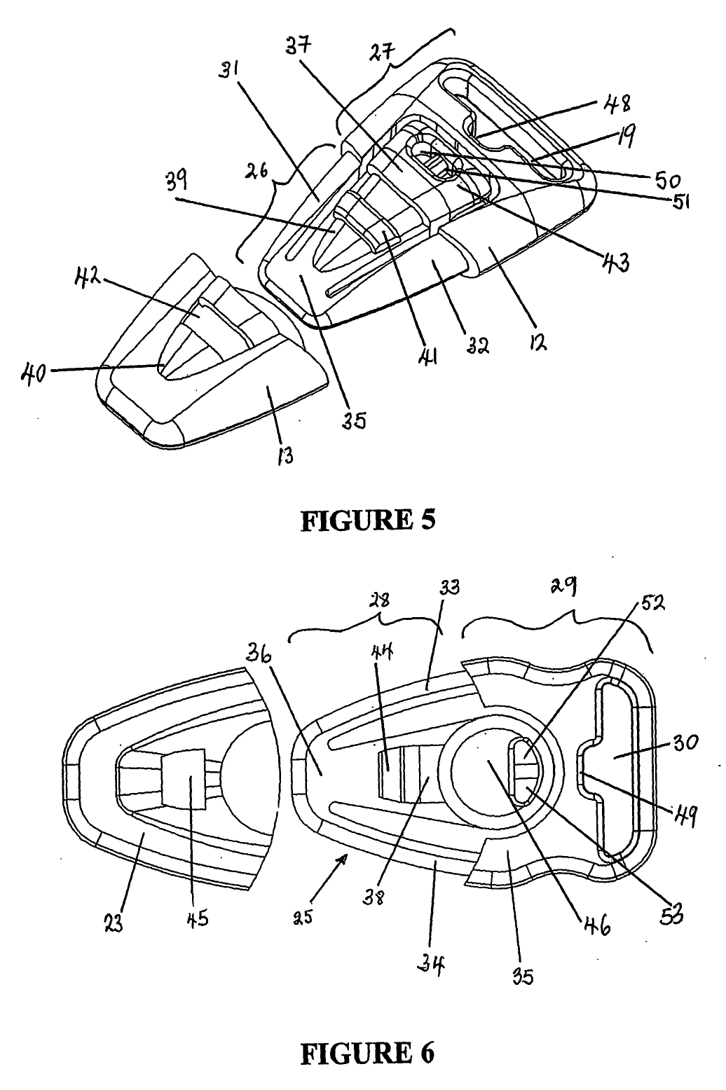

Reference is now made to FIGS. 5 and 6 that each illustrates the female and male connectors of the preferred form and the alternative forms of the present invention respectively. The female connectors 13, 23 define a recess which approximates a tapered rectangular form, the recess is adapted to provide a close fit with the corresponding male connector 12, 25 when the connectors are engaged.

The male connectors 12, 25 each have leading portions 26, 28 that are tapered in shape and which are received in the corresponding recesses of the female connectors 13,23, and trailing portions 27, 29 which remain outside the recess. The elongated apertures 19, 30, to which the headgear strap 16 is threaded through, are formed at the ends of the trailing portions 27,29. The leading portions 26, 28 each include upper 31, 33 and lower 32, 34 arms connected by cross pieces 35, 36 at their leading ends, and resiliently based cantilever members 37, 38 depending from the cross pieces 35,36, extending back towards and extending into the centre of the trailing portions 27, 29.

The male connector 12 of FIG. 5 has a raised portion 39 on the cantilever member 37 which fits within a corresponding raised recess part 40 in the female connector 13 when the male and female connectors are engaged. On the raised portion 39 is a protrusion 41, that during engagement of the connectors 12, 13, slides along the underside of the raised recess part 40 and fits into a correspondingly shaped aperture 42 in the raised recess part 40. The fitting of the protrusion 41 within the aperture 42 causes a locking effect between the male connector and female connector. In order for the protrusion 41 to be released from the aperture 42 the flexible end 43 of the cantilever member 37 must be depressed to cause the protrusion 41 to move downwards out of the aperture 42 so that the male connector 12 can be disengaged from the female connector 13.

The male connector 25 of FIG. 6 does not have a raised portion like that of FIG. 5, but does have a protrusion 44 and aperture 45 fitting between the male and female connectors similar to that described above. Again, when the flexible end 46 of the cantilever member 38 is depressed the protrusion 44 is released from the aperture 45 and the male connector 25 is released from the female connector 23.

The association of the male connector 25 with the release cord will now be described with reference to FIGS. 6 to 9 which show the harnessing clip of FIG. 5 in side and cross-sectional views. The release cord 14 is attached to the cantilever member 37 of the male connector 12 and runs from the cantilever member 37, beneath the back area 47 of the trailing portion 27, up through the elongated aperture 19 and along the length of the headgear strap 16. An indentation 48, 49 (as shown in FIGS. 5 and 6 respectively) may be provided in the back area 47 of the trailing portion 27 which acts as a guide for the release cord 14. The cord 14 is affixed to the cantilever member 37 by any appropriate means, for example, a knot could be formed in the end of the cord 14 and the cord 14 can then be threaded through an aperture formed in the cantilever member (not shown) to then be threaded beneath the back area 47 and up through the elongated aperture 19. The knot in the cord 14 will prevent the cord from passing through the male connector 12. In other forms two apertures 50 and 51, 52 and 53 (as shown in FIGS. 5 and 6 respectively) could be formed in the cantilever member 37 or 38 so that the release cord 14 would be threaded through each of the apertures 50 and 51, 52 and 53 forming a “double” cord that is utilised as the release cord 14.

As the release cord 14 is attached to the cantilever member 37 of the male connector 12 when a user pulls on the release cord 14 the cantilever member 37 is pulled downwards. As tension exists between the male and female connectors, the leading portion 26 of the male connector 12 is released from the female connector 13. This in turn releases the headgear strap 16 from the mask 2 and it falls away from the user's face.

1. A release mechanism for an interface to enable a user to
quickly remove said interface from said users' face, comprising or including:
at least one strap having two ends where one end in use is flexibly coupled to releasable connector provided at least on one side of said mask, and the other of said two ends flexibly coupled to a mask attachment at the other side of said mask, said strap extending around the back of the user's head,
a cord attached to said releasable connector that when said mask is in use and said cord is pulled by said user said releasable connector causes said at least one strap to be released from said mask thereby causing said mask to fall from said users' face.

2. A release mechanism according to claim 1 wherein said interface is a full face mask.

3. A release mechanism according to claim 1 wherein said releasable connector harnessing clip comprising a male connector and female connector capable of being coupled together.

4. A release mechanism according to claim 3 wherein one of said two ends of said at least one strap is attached to one of said male connector and said female connector.

5. A release mechanism according to claim 3 or 4 wherein the other one of said male connector and said female connector is flexibly attached to said mask.

6. A release mechanism according to claim 1 wherein said flexible attachment is achieved by a sliding engagement adapted to engage one of said male connector and said female connector with said mask.

7. A release mechanism according to claim 6 wherein said sliding engagement is adapted to allow said at least one strap substantial movement with respect to said mask while still providing a compressive force to seal said mask to said users' face.

8. A release mechanism according to claim 6 wherein said sliding engagement includes an elongate member slidably engaged to said interface and engaged to at least one releasably connecting means.

9. A release mechanism according to claim 8 wherein said elongate member has a first end and a second end, a closed loop located at said first end and said harnessing clip located at said second end.

10. A release mechanism according to claim 9 wherein said closed loop and one of said male connector and said female connector of said harnessing clip are integrally formed with said elongate member.

11. A release mechanism according to claim 6 wherein said sliding engagement is a loop adapted to pass over and slidingly engage with said interface.

12. A release mechanism according to claim 8 or 11 wherein said sliding engagement includes a restraining member, said restraining member adapted to in use accommodate said elongate member or said loop, said restraining member adapted in use to restrain said member or said loop in at least one dimension, but allow said member or said loop to slide easily within at least one other dimension, said restraining member adapted to in use easily disengage with said elongate member or said loop.

13. A release mechanism according to claim 1 wherein said mask attachment is a loop in which one of said two ends of said strap can be attached to.

14. A release mechanism according to claim 1 wherein said mask attachment is a releasable connector.

15. A mask having a release mechanism that enables a user to quickly remove said mask from said user's face, comprising or including:
at least one strap having two ends each adapted to, in use, be flexibly coupled to releasable connector at least on one side of said mask and a mask attachment at the other side of said mask, and around the back of the user's head,
a cord attached to said releasable connector that when said mask is in use and said cord is pulled by said user said releasable connector causes said at least one strap to be released from said mask thereby causing said mask to fall from said user's face.

16. A patient interface for delivering a supply of gases to a user comprising or including:
headgear attached to or around the head of said user,
a sliding engagement adapted to engage said headgear with said patient interface,
release mechanism coupled between said headgear and said sliding engagement that when actuated by said user causes the separation of said sliding engagement and said headgear.

17. A patient interface according to claim 16 wherein said release mechanism comprises or includes:
a harnessing clip comprising a male connector and a female connector capable of being coupled together, one of said male connector and said female connector attached to said headgear, and
a cord attached to the other of said male connector and said female connector, which when said interface is in use and said cord is pulled by said user said male connector and said female connector are disengaged and said headgear released from said mask thereby causing said mask to fall from said user's face.

18. A patient interface according to claim 16 wherein said sliding engagement comprises or includes:
an elongate member slidably engaged to said interface, and
restraining member, adapted to in use accommodate said elongate member, said restraining member adapted in use to restrain said elongate member in at least one dimension, but allow said member to slide easily within at least one other dimension, said restraining member adapted to in use easily disengage with said elongate member.

19. A patient interface according to claim 18 wherein said elongate member has a first end and a second end, a closed loop located at said first end and said harnessing clip at said second end.

20. A patient interface according to claim 11 wherein said closed loop and one of said male connector and said female connector of said harnessing clip are integrally formed with said elongate member.

21. A patient interface according to claim 16 wherein said sliding engagement comprises or includes:
a loop adapted to pass over and slidingly engage with said interface, and
restraining member adapted to in use accommodate said loop, said restraining member adapted in use to restrain said loop in at least one dimension, but allow said loop to slide easily within at least one other dimension, said restraining means adapted to in use easily disengage with said loop.

22. A patient interface according to claim 21 wherein said loop is elliptical in shape having a first end and a second end where a closed loop is located at said first end and said harnessing clip is located at said second end.

23. A patient interface according to claim 22 wherein said closed loop and one of said male connector and said female connector of said harnessing clip are integrally formed with said loop.

24. (canceled)

25. (canceled)

26. (canceled)
